(19) United States
(12) Patent Application Publication
(10) Pub. No.: US 2017/0237292 A1
(43) Pub. Date: Aug. 17, 2017

(54) RECONFIGURABLE MULTI-MODE ANTENNA FOR WIRELESS POWER TRANSFER

(71) Applicant: QUALCOMM Incorporated, San Diego, CA (US)

(72) Inventors: Seong Heon Jeong, San Diego, CA (US); Linda Stacey Irish, San Diego, CA (US); William Henry Von Novak, III, San Diego, CA (US)

(21) Appl. No.: 15/042,191

(22) Filed: Feb. 12, 2016

(51) Int. Cl. H02J 50/12; H02J 50/80; H02J 7/02; H02J 50/90; H04B 5/00; H02J 50/05

(52) U.S. Cl. CPC H02J 50/12; H04B 5/0037; H04B 5/0093; H02J 50/05; H02J 7/025; H02J 50/90; H02J 50/80

(57) ABSTRACT

A reconfigurable wireless power transmit antenna includes an antenna coil configured in a first configuration having a first number of turns configured to operate at a first frequency, the antenna coil configurable in a second configuration having a second number of turns configured to operate at a second frequency, and a switching mechanism configured to switch between the first configuration and the second configuration.

### FIELD

The present disclosure relates generally to wireless power. More specifically, the disclosure is directed to a reconfigurable multi-mode transmit antenna for wireless power transfer.

### BACKGROUND

An increasing number and variety of electronic devices are powered via rechargeable batteries. Such devices include mobile phones, portable music players, laptop computers, tablet computers, computer peripheral devices, communication devices (e.g., Bluetooth devices), digital cameras, hearing aids, and the like. While battery technology has improved, battery-powered electronic devices increasingly require and consume greater amounts of power, thereby often requiring recharging. Rechargeable devices are often charged via wired connections that require cables or other similar connectors that are physically connected to a power supply. Cables and similar connectors may sometimes be inconvenient or cumbersome and have other drawbacks. Wireless charging systems that are capable of transferring power in free space to be used to charge rechargeable electronic devices may overcome some of the deficiencies of wired charging solutions. As such, wireless charging systems and methods that efficiently and safely transfer power for charging rechargeable electronic devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a reconfigurable wireless power transmit antenna including an antenna coil configured in a first configuration having a first number of turns configured to operate at a first frequency, the antenna coil configurable in a second configuration having a second number of turns configured to operate at a second frequency, and a switching mechanism configured to switch between the first configuration and the second configuration.

Another aspect of the disclosure provides a reconfigurable wireless power transmit antenna including an antenna coil configured in a first configuration having a first number of turns configured to operate at a first frequency, the antenna coil configurable in a second configuration having a second number of turns configured to operate at a second frequency, and a switching mechanism configured to switch between the first configuration and the second configuration responsive to a frequency of a wireless power transfer signal.

Another aspect of the disclosure provides a device for wireless power transfer including means for configuring an antenna coil in a first configuration having a first number of turns configured to operate at a first frequency, and means for reconfiguring the antenna coil in a second configuration having a second number of turns configured to operate at a second frequency.

Another aspect of the disclosure provides a method for wireless power transfer including configuring an antenna coil in a first configuration having a first number of turns configured to operate at a first frequency, and reconfiguring the antenna coil in a second configuration having a second number of turns configured to operate at a second frequency.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram of an exemplary wireless power transfer system, in accordance with exemplary embodiments of the invention.

FIG. 2 is a functional block diagram of exemplary components that may be used in the wireless power transfer system of FIG. 1, in accordance with various exemplary embodiments of the invention.

FIG. 3 is a schematic diagram of a portion of transmit circuitry or receive circuitry of FIG. 2 including a transmit or receive antenna, in accordance with exemplary embodiments of the invention.

FIG. 4 is a functional block diagram of a transmitter that may be used in the wireless power transfer system of FIG. 1, in accordance with exemplary embodiments of the invention.

FIG. 5 is a functional block diagram of a receiver that may be used in the wireless power transfer system of FIG. 1, in accordance with exemplary embodiments of the invention.

FIG. 6 is a schematic diagram of a portion of transmit circuitry that may be used in the transmit circuitry of FIG. 4.

FIG. 7A is a simplified diagram illustrating an exemplary embodiment of a reconfigurable multi-mode antenna.

FIG. 7B is a simplified diagram illustrating an alternative exemplary embodiment of the reconfigurable multi-mode antenna of FIG. 7A.

FIG. 8A is a simplified diagram illustrating an exemplary embodiment of a reconfigurable multi-mode antenna.

FIG. 8B is a simplified diagram illustrating an alternative exemplary embodiment of the reconfigurable multi-mode antenna of FIG. 8A.

FIG. 9 is a simplified diagram illustrating an exemplary embodiment of a wireless power transfer system.

FIG. 10A is an exemplary embodiment of an antenna coil and switching circuitry of FIG. 9.

FIG. 10B is an alternative exemplary embodiment of an antenna coil and switching circuitry of FIG. 9.

FIG. 11A is an exemplary embodiment of the switching circuitry of FIG. 10A.

FIG. 11B is an exemplary embodiment of the switching circuitry of FIG. 10B.

FIG. 12A is a simplified diagram illustrating an exemplary embodiment of a reconfigurable multi-mode antenna.

FIG. 12B is a schematic diagram showing an equivalent circuit representation of the reconfigurable multi-mode antenna of FIG. 12A.

FIG. 13 is a schematic diagram showing an alternative embodiment of a circuit representation of a reconfigurable multi-mode antenna.

FIG. 14 is a flowchart illustrating an exemplary embodiment of a method for a reconfigurable multi-mode antenna.

FIG. 15 is a functional block diagram of an apparatus for a reconfigurable multi-mode antenna.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. In some instances, some devices are shown in block diagram form.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving antenna” to achieve power transfer.

Wireless charging systems may produce magnetic charging fields at certain frequencies. A transmit antenna and a receive antenna can be configured to operate at or near a resonant frequency, at which the wireless transfer of power via a magnetic charging field becomes efficient. When operating at or near a resonant frequency, a transmit antenna may be referred to as a transmit resonator and a receive antenna may be referred to as a receive resonator. A transmit antenna designed to efficiently transfer power at a high frequency (for example, >1 MHz) is designed to a set of requirements that are appropriate for higher frequencies. A transmit antenna designed to operate a high frequency may include wide spacing between the windings, or turns, of the antenna (to avoid or minimize self-resonance), has thin or plated resonance materials to reduce the effect of a phenomenon known as skin effect. The term “skin effect” refers to the tendency of an alternating electric current (AC) to become distributed within a conductor such that the current density of the alternating electric current is largest near the surface of the conductor, and decreases at greater depths in the conductor. The term “skin depth” refers to a measure of how closely an alternating electric current flows along the surface of a material. For example, at DC (0 Hz or a constant voltage), electric current flows uniformly through a conductor. This means that the DC current density is typically consistent throughout the conductor. However, at higher frequencies (non-DC), most of the current typically flows along the surface of the conductor, producing surface current. Further, a transmit antenna designed to operate a high frequency generally has a reduced number of windings or turns to reduce AC resistance.

A transmit antenna designed to efficiently transfer power at a low frequency (for example <1 MHz) is designed to a different set of requirements than a transmit antenna designed to efficiently transfer power at a high frequency(for example >1 MHz). A transmit antenna designed to operate a low frequency may include a large number of windings, or turns, to achieve the same magnetic field (H-field) as a transmit antenna designed for high frequency operation because the magnetic field strength is proportional to the operating frequency. The spacing between windings, or turns, is less important for an antenna designed to operate a low frequency since the point of self-resonance for a low frequency antenna is farther away from the low frequencies involved. The skin depth of a transmit antenna designed to efficiently transfer power at a low frequency is thicker than the skin depth for a high frequency antenna. Implementing the low frequency antenna as a Litz wire, can be implemented at low frequencies. From this it is clear that a transmit antenna optimized for one frequency may have reduced performance for other frequencies. For example, a transmit antenna designed to operate at a high frequency may have few windings, or turns, so as to minimize inter-winding capacitance, but a large amount of current may be desirable to transmit a sufficient magnetic field at low frequencies because the strength of a magnetic field is proportional to operating frequency. Therefore, it would be desirable to have a reconfigurable antenna that can be used to wirelessly transfer power at more than one frequency.

As used herein, the term “bifilar” refers to a coil or antenna having two parallel turns, or windings.

As used herein, the terms “mono-filar” and “single-filar” refer to a coil or antenna having a single continuous conductor that may be wound one or more turns or have one or more windings.

As used herein, the term “X-filar” refers to a coil or antenna having one continuous conductor that may be wound one or more turns or have one or more windings, where the “X” refers to the number of turns or windings.

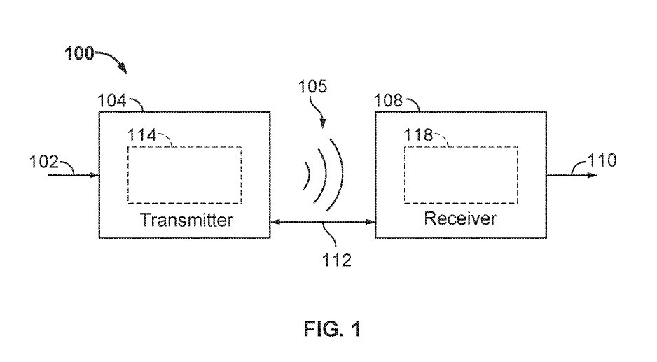

FIG. 1 is a functional block diagram of an exemplary wireless power transfer system 100, in accordance with exemplary embodiments of the invention. Input power 102 may be provided to a transmitter 104 from a power source (not shown) for generating a field 105 (e.g., magnetic or species of electromagnetic) for providing energy transfer. A receiver 108 may couple to the field 105 and generate output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship. When the resonant frequency of receiver 108 and the resonant frequency of transmitter 104 are substantially the same or very close, transmission losses between the transmitter 104 and the receiver 108 are reduced. As such, wireless power transfer may be provided over larger distances in contrast to purely inductive solutions that may require large coils to be very close (e.g., millimeters). Resonant inductive coupling techniques may thus allow for improved efficiency and power transfer over various distances and with a variety of inductive coil configurations.

The receiver 108 may receive power when the receiver 108 is located in an energy field 105 produced by the transmitter 104. The field 105 corresponds to a region where energy output by the transmitter 104 may be captured by a receiver 108. The transmitter 104 may include a transmit antenna 114 (that may also be referred to herein as a coil) for outputting an energy transmission. The receiver 108 further includes a receive antenna 118 (that may also be referred to herein as a coil) for receiving or capturing energy from the energy transmission. In some cases, the field 105 may correspond to the “near-field” of the transmitter 104. The near-field may correspond to a region in which there are strong reactive fields resulting from the currents and charges in the transmit antenna 114 that minimally radiate power away from the transmit antenna 114. In some cases the near-field may correspond to a region that is within about one wavelength (or a fraction thereof) of the transmit antenna 114.

In accordance with the above therefore, in accordance with more particular embodiments, the transmitter 104 may be configured to output a time varying magnetic field 105 with a frequency corresponding to the resonant frequency of the transmit antenna 114. When the receiver is within the field 105, the time varying magnetic field 105 may induce a voltage in the receive antenna 118 that causes an electrical current to flow through the receive antenna 118. As described above, if the receive antenna 118 is configured to be resonant at the frequency of the transmit antenna 114, energy may be efficiently transferred. The AC signal induced in the receive antenna 118 may be rectified to produce a DC signal that may be provided to charge or to power a load.

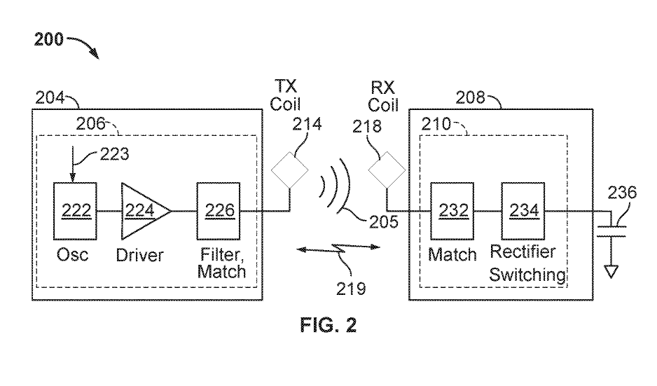

FIG. 2 is a functional block diagram of a wireless power transfer system 200 that includes exemplary components that may be used in the wireless power transfer system 100 of FIG. 1, in accordance with various exemplary embodiments of the invention. The transmitter 204 may include transmit circuitry 206 that may include an oscillator 222, a driver circuit 224, and a filter and matching circuit 226. The oscillator 222 may be configured to generate a signal at a desired frequency, such as 468.75 KHz, 6.78 MHz or 13.56 MHz, that may be adjusted in response to a frequency control signal 223. The oscillator signal may be provided to a driver circuit 224 configured to drive the transmit antenna 214 at, for example, a resonant frequency of the transmit antenna 214. The driver circuit 224 may be a switching amplifier configured to receive a square wave from the oscillator 222 and output a sine wave. For example, the driver circuit 224 may be a class E amplifier. A filter and matching circuit 226 may be also included to filter out harmonics or other unwanted frequencies and match the impedance of the transmitter 204 to the impedance of the transmit antenna 214. As a result of driving the transmit antenna 214, the transmitter 204 may wirelessly output power at a level sufficient for charging or powering an electronic device. As one example, the power provided may be for example on the order of 300 milliWatts to 5 Watts or 5 Watts to 40 Watts to power or charge different devices with different power requirements. Higher or lower power levels may also be provided.

The receiver 208 may include receive circuitry 210 that may include a matching circuit 232 and a rectifier and switching circuit 234 to generate a DC power output from an AC power input to charge a battery 236 as shown in FIG. 2 or to power a device (not shown) coupled to the receiver 208. The matching circuit 232 may be included to match the impedance of the receive circuitry 210 to the impedance of the receive antenna 218. The receiver 208 and transmitter 204 may additionally communicate on a separate communication channel 219 (e.g., Bluetooth, zigbee, cellular, etc.). The receiver 208 and transmitter 204 may alternatively communicate via in-band signaling using characteristics of the wireless field 205.

The receiver 208 may initially have a selectively disablable associated load (e.g., battery 236), and may be configured to determine whether an amount of power transmitted by transmitter 204 and received by receiver 208 is appropriate for charging a battery 236. Further, receiver 208 may be configured to enable a load (e.g., battery 236) upon determining that the amount of power is appropriate.

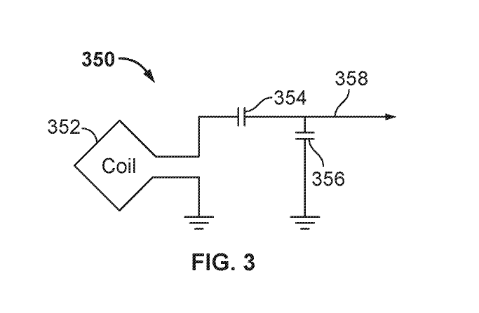

FIG. 3 is a schematic diagram of a portion of transmit circuitry 206 or receive circuitry 210 of FIG. 2 including a transmit or receive antenna 352, in accordance with exemplary embodiments of the invention. As illustrated in FIG. 3, transmit or receive circuitry 350 used in exemplary embodiments including those described below may include an antenna 352. The antenna 352 may also be referred to or be configured as a “loop” antenna 352. The antenna 352 may also be referred to herein or be configured as a “magnetic” antenna or an induction coil. The term “antenna” generally refers to a component that may wirelessly output or receive energy for coupling to another “antenna.” The antenna 352 may also be referred to as a coil of a type that is configured to wirelessly output or receive power. As used herein, an antenna 352 is an example of a “power transfer component” of a type that is configured to wirelessly output and/or receive power. The antenna 352 may be configured to include an air core or a physical core such as a ferrite core (not shown).

The antenna 352 may form a portion of a resonant circuit configured to resonate at a resonant frequency. The resonant frequency of the loop or magnetic antenna 352 is based on the inductance and capacitance. Inductance may be simply the inductance created by the antenna 352, whereas, capacitance may be added to create a resonant structure (e.g., a capacitor may be electrically connected to the antenna 352 in series or in parallel) at a desired resonant frequency. As a non-limiting example, capacitor 354 and capacitor 356 may be added to the transmit or receive circuitry 350 to create a resonant circuit that resonates at a desired frequency of operation. For larger diameter antennas, the size of capacitance needed to sustain resonance may decrease as the diameter or inductance of the loop increases. As the diameter of the antenna increases, the efficient energy transfer area of the near-field may increase. Other resonant circuits formed using other components are also possible. As another non-limiting example, a capacitor (not shown) may be placed in parallel between the two terminals of the antenna 352. For transmit antennas, a signal 358 with a frequency that substantially corresponds to the resonant frequency of the antenna 352 may be an input to the antenna 352. For receive antennas, the signal 358 may be the output that may be rectified and used to power or charge a load.

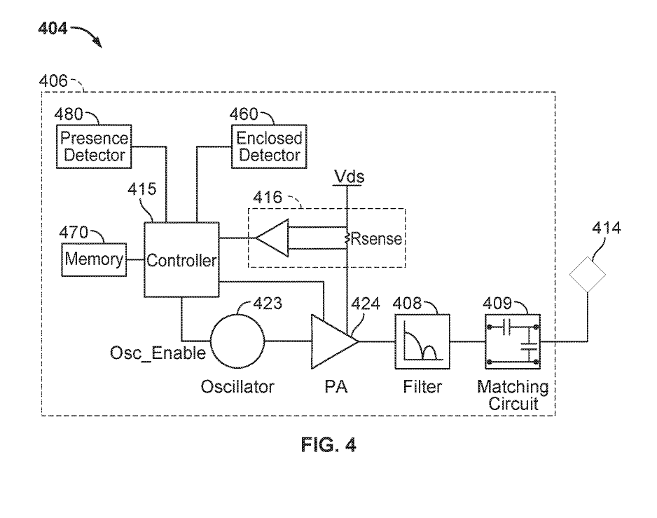

FIG. 4 is a functional block diagram of a transmitter 404 that may be used in the wireless power transfer system of FIG. 1, in accordance with exemplary embodiments of the invention. The transmitter 404 may include transmit circuitry 406 and a transmit antenna 414. The transmit antenna 414 may be the antenna 352 as shown in FIG. 3. The transmit antenna 414 may be configured as the transmit antenna 214 as described above in reference to FIG. 2. In some implementations, the transmit antenna 414 may be a coil (e.g., an induction coil). In some implementations, the transmit antenna 414 may be associated with a larger structure, such as a pad, table, mat, lamp, or other stationary configuration. Transmit circuitry 406 may provide power to the transmit antenna 414 by providing an oscillating signal resulting in generation of energy (e.g., magnetic flux) about the transmit antenna 414. Transmitter 404 may operate at any suitable frequency. By way of example, transmitter 404 may operate at the 6.78 MHz ISM band.

Transmit circuitry 406 may include a fixed impedance matching circuit 409 for matching the impedance of the transmit circuitry 406 (e.g., 50 ohms) to the impedance of the transmit antenna 414 and a low pass filter (LPF) 408 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that may be varied based on measurable transmit metrics, such as output power to the antenna 414 or DC current drawn by the driver circuit 424. Transmit circuitry 406 further includes a driver circuit 424 configured to drive a signal as determined by an oscillator 423. The transmit circuitry 406 may be comprised of discrete devices or circuits, or alternately, may be comprised of an integrated assembly.

Transmit circuitry 406 may further include a controller 415 for selectively enabling the oscillator 423 during transmit phases (or duty cycles) for specific receivers, for adjusting the frequency or phase of the oscillator 423, and for adjusting the output power level for implementing a communication protocol for interacting with neighboring devices through their attached receivers. It is noted that the controller 415 may also be referred to herein as a processor. Adjustment of oscillator phase and related circuitry in the transmission path may allow for reduction of out of band emissions, especially when transitioning from one frequency to another. A memory 470 may be coupled to the controller 415.

The transmit circuitry 406 may further include a load sensing circuit 416 for detecting the presence or absence of active receivers in the vicinity of the near-field generated by transmit antenna 414. By way of example, a load sensing circuit 416 monitors the current flowing to the driver circuit 424, that may be affected by the presence or absence of active receivers in the vicinity of the field generated by transmit antenna 414 as will be further described below. Detection of changes to the loading on the driver circuit 424 are monitored by controller 415 for use in determining whether to enable the oscillator 423 for transmitting energy and to communicate with an active receiver.

The transmit antenna 414 may be implemented with a Litz wire or as an antenna strip with the thickness, width and metal type selected to keep resistive losses low.

The transmitter 404 may gather and track information about the whereabouts and status of receiver devices that may be associated with the transmitter 404. Thus, the transmit circuitry 406 may include a presence detector 480, an enclosed detector 460, or a combination thereof, connected to the controller 415 (also referred to as a processor herein). The controller 415 may adjust an amount of power delivered by the driver circuit 424 in response to presence signals from the presence detector 480 and the enclosed detector 460. The transmitter 404 may receive power through a number of power sources, such as, for example, an AC-DC converter (not shown) to convert AC power present in a building, a DC-DC converter (not shown) to convert a DC power source to a voltage suitable for the transmitter 404, or directly from a DC power source (not shown).

As a non-limiting example, the presence detector 480 may be a motion detector utilized to sense the initial presence of a device to be charged that is inserted into the coverage area of the transmitter 404. After detection, the transmitter 404 may be turned on and the power received by the device may be used to toggle a switch on the receiver device in a pre-determined manner, which in turn results in changes to the driving point impedance of the transmitter 404.

As another non-limiting example, the presence detector 480 may be a detector capable of detecting a human, for example, by infrared detection, motion detection, or other suitable means. In some exemplary embodiments, there may be regulations limiting the amount of power that a transmit antenna 414 may transmit at a specific frequency. In some cases, these regulations are meant to protect humans from electromagnetic radiation. However, there may be environments where a transmit antenna 414 is placed in areas not occupied by humans, or occupied infrequently by humans, such as, for example, garages, factory floors, shops, and the like. If these environments are free from humans, it may be permissible to increase the power output of the transmit antenna 414 above the normal power restrictions regulations. In other words, the controller 415 may adjust the power output of the transmit antenna 414 to a regulatory level or lower in response to human presence and adjust the power output of the transmit antenna 414 to a level above the regulatory level when a human is outside a regulatory distance from the wireless charging field of the transmit antenna 414.

As a non-limiting example, the enclosed detector 460 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 404 does not remain on indefinitely may be used. In this case, the transmitter 404 may be programmed to shut off after a user-determined amount of time. This feature prevents the transmitter 404, notably the driver circuit 424, from running long after the wireless devices in its perimeter are fully charged. This event may be due to the failure of the circuit to detect the signal sent from either the repeater or the receive antenna 218 that a device is fully charged. To prevent the transmitter 404 from automatically shutting down if another device is placed in its perimeter, the transmitter 404 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

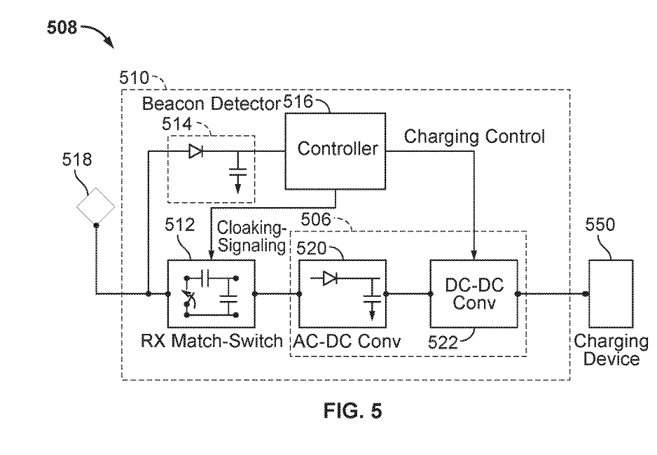

FIG. 5 is a functional block diagram of a receiver 508 that may be used in the wireless power transfer system of FIG. 1, in accordance with exemplary embodiments of the invention. The receiver 508 includes receive circuitry 510 that may include a receive antenna 518. Receiver 508 further couples to device 550 for providing received power thereto. It should be noted that receiver 508 is illustrated as being external to device 550 but may be integrated into device 550. Energy may be propagated wirelessly to receive antenna 518 and then coupled through the rest of the receive circuitry 510 to device 550. By way of example, the charging device may include devices such as mobile phones, portable music players, laptop computers, tablet computers, computer peripheral devices, communication devices (e.g., Bluetooth devices), digital cameras, hearing aids (and other medical devices), wearable devices, and the like.

Receive antenna 518 may be tuned to resonate at the same frequency, or within a specified range of frequencies, as transmit antenna 414 (FIG. 4). Receive antenna 518 may be similarly dimensioned with transmit antenna 414 or may be differently sized based upon the dimensions of the associated device 550. By way of example, device 550 may be a portable electronic device having diametric or length dimension smaller than the diameter or length of transmit antenna 414. In such an example, receive antenna 518 may be implemented as a multi-turn coil in order to reduce the capacitance value of a tuning capacitor (not shown) and increase the receive coil's impedance. By way of example, receive antenna 518 may be placed around the substantial circumference of device 550 in order to maximize the antenna diameter and reduce the number of loop turns (i.e., windings) of the receive antenna 518 and the inter-winding capacitance.

Receive circuitry 510 may provide an impedance match to the receive antenna 518. Receive circuitry 510 includes power conversion circuitry 506 for converting a received energy into charging power for use by the device 550. Power conversion circuitry 506 includes an AC-to-DC converter 520 and may also include a DC-to-DC converter 522. AC-to-DC converter 520 rectifies the energy signal received at receive antenna 518 into a non-alternating power with an output voltage. The DC-to-DC converter 522 (or other power regulator) converts the rectified energy signal into an energy potential (e.g., voltage) that is compatible with device 550 with an output voltage and output current. Various AC-to-DC converters are contemplated, including partial and full rectifiers, regulators, bridges, doublers, as well as linear and switching converters.

Receive circuitry 510 may further include RX matching and switching circuitry 512 for connecting receive antenna 518 to the power conversion circuitry 506 or alternatively for disconnecting the power conversion circuitry 506. Disconnecting receive antenna 518 from power conversion circuitry 506 not only suspends charging of device 550, but also changes the “load” as “seen” by the transmitter 404 (FIG. 2).

When multiple receivers 508 are present in a transmitter's near-field, it may be desirable to adjust the loading and unloading of one or more receivers to enable other receivers to more efficiently couple to the transmitter. A receiver 508 may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 508 and detected by transmitter 404 may provide a communication mechanism from receiver 508 to transmitter 404. Additionally, a protocol may be associated with the switching that enables the sending of a message from receiver 508 to transmitter 404. By way of example, a switching speed may be on the order of 100 μsec.

In an exemplary embodiment, communication between the transmitter 404 and the receiver 508 may take place either via an “out-of-band” separate communication channel/antenna or via “in-band” communication that may occur via modulation of the field used for power transfer.

Receive circuitry 510 may further include signaling detector and beacon circuitry 514 used to identify received energy fluctuations that may correspond to informational signaling from the transmitter to the receiver. Furthermore, signaling and beacon circuitry 514 may also be used to detect the transmission of a reduced signal energy (i.e., a beacon signal) and to rectify the reduced signal energy into a nominal power for awakening either un-powered or power-depleted circuits within receive circuitry 510 in order to configure receive circuitry 510 for wireless charging.

Receive circuitry 510 further includes controller 516 for coordinating the processes of receiver 508 described herein including the control of RX matching and switching circuitry 512 described herein. It is noted that the controller 516 may also be referred to herein as a processor. Cloaking of receiver 508 may also occur upon the occurrence of other events including detection of an external wired charging source (e.g., wall/USB power) providing charging power to device 550. Controller 516, in addition to controlling the cloaking of the receiver, may also monitor beacon circuitry 514 to determine a beacon state and extract messages sent from the transmitter 404. Controller 516 may also adjust the DC-to-DC converter 522 for improved performance.

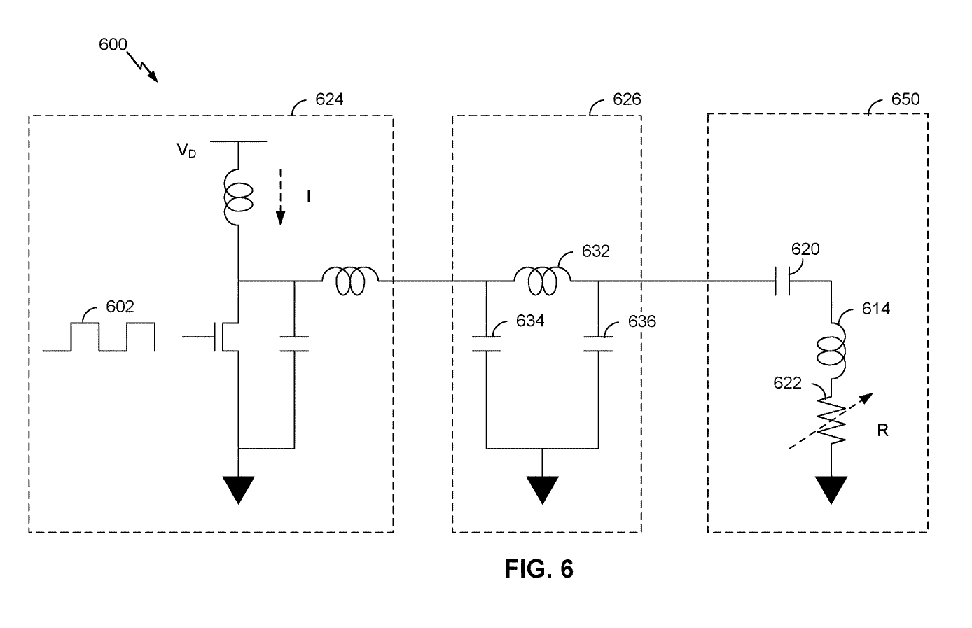

FIG. 6 is a schematic diagram of a portion of transmit circuitry 600 that may be used in the transmit circuitry 406 of FIG. 4. The transmit circuitry 600 may include a driver circuit 624 as described above in FIG. 4. As described above, the driver circuit 624 may be a switching amplifier that may be configured to receive a square wave and output a sine wave to be provided to the transmit circuit 650. In some cases the driver circuit 624 may be referred to as an amplifier circuit. The driver circuit 624 is shown as a class E amplifier, however, any suitable driver circuit 624 may be used in accordance with embodiments of the invention. The driver circuit 624 may be driven by an input signal 602 from an oscillator 423 as shown in FIG. 4. The driver circuit 624 may also be provided with a drive voltage V_{D} that is configured to control the maximum power that may be delivered through a transmit circuit 650. To eliminate or reduce harmonics, the transmit circuitry 600 may include a filter circuit 626. The filter circuit 626 may be a three pole (capacitor 634, inductor 632, and capacitor 636) low pass filter circuit 626.

The signal output by the filter circuit 626 may be provided to a transmit circuit 650 comprising an antenna 614. The transmit circuit 650 may include a series resonant circuit having a capacitance 620 and inductance (e.g., that may be due to the inductance or capacitance of the antenna or to an additional capacitor component) that may resonate at a frequency of the filtered signal provided by the driver circuit 624. The load of the transmit circuit 650 may be represented by the variable resistor 622. The load may be a function of a wireless power receiver 508 that is positioned to receive power from the transmit circuit 650.

In an exemplary embodiment, a multi-mode antenna for wireless power transfer can be reconfigured to provide an antenna structure that can be used to provide wireless power transfer at two different frequencies or in two different frequency bands.

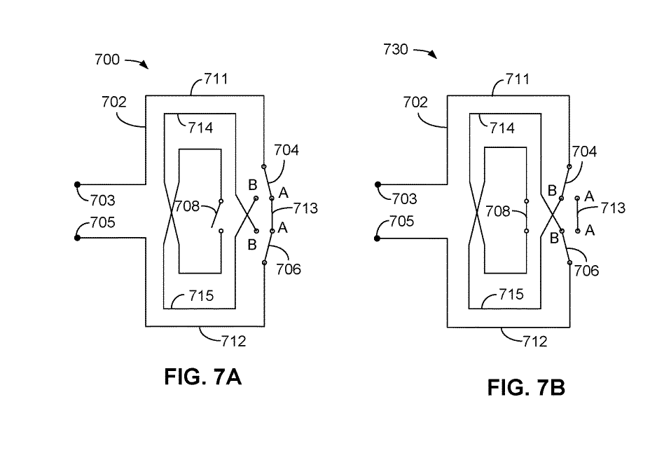

FIG. 7A is a simplified diagram illustrating an exemplary embodiment of a reconfigurable multi-mode antenna 700. The reconfigurable multi-mode antenna 700 can be associated with, contained in, or can be a portion of a charging surface that may comprise a pad, table, mat, lamp, or other element associated with a wireless charging system. In an embodiment, the reconfigurable multi-mode antenna 700 may be part of a pad having a wireless charging surface on or by which a charge-receiving device may be placed to wirelessly receive power.

While the following description of the exemplary embodiments describes embodiments relative to a reconfigurable multi-mode antenna that can be configured as part of a circuit for power transfer, the embodiments thereof described herein may also be incorporated into resonant structures configured for resonant power transfer systems. Further, while the following description of the exemplary embodiments describes embodiments relative to a reconfigurable multi-mode transmit antenna, the embodiments thereof described herein may also be incorporated into a reconfigurable multi-mode receive antenna.

In an exemplary embodiment, the reconfigurable multi-mode antenna 700 comprises an antenna coil 702 having antenna segments 711, 712, 713, 714 and 715. The “antenna coil” may also be referred to as an “antenna loop.” The antenna coil 702 may comprise “turns” or “windings”, which generally refer to the number of coils or loops that comprise the antenna coil 702. The reconfigurable multi-mode antenna 700 comprises input terminals 703 and 705. The reconfigurable multi-mode antenna 700 also comprises switches 704, 706 and 708. While shown schematically as single pole single throw switches, the switches 704, 706 and 708 may be implemented using various switch technologies, such as, for example only, diodes, relays, isolated bidirectional field effect transistors (FETs) or other semiconductor switch technologies. In an exemplary embodiment, the switches 704, 706 and 708 may be controlled by the controller 415 (FIG. 4), based, at least in part, on a characteristic of the power transfer signal. For example, the switches 704, 706 and 708 may be controlled by the controller 415 (FIG. 4), based, at least in part, on the frequency of the power transfer signal. The antenna coil 702 may be configured to operate with single-ended transmit circuity 406 in which one input terminal 703 and 705 may be coupled to the output of the transmit circuitry 406 and the other input terminal 703 and 705 may be coupled to a ground reference. Alternatively, the antenna coil 702 may be configured to operate with balanced (also referred to as differential) transmit circuity 406 in which the input terminals 703 and 705 may be coupled to a differential output of the transmit circuitry 406.

In an exemplary embodiment where the switch 704 and the switch 706 are in position denoted as “A” and the switch 708 is open, the reconfigurable multi-mode antenna 700 is configured as a single loop that may be used as a high frequency wireless power transmit antenna. The term “single loop” refers to the switches 704, 706 and 708 configuring the antenna coil 702 so that antenna segments 711, 713 and 712 are coupled to the input terminals 703 and 705, and such that antenna segments 714 and 715 are electrically isolated from the antenna coil 702. The configuration shown in FIG. 7A may be appropriate for a high frequency wireless transmit antenna application where a single antenna coil is desired.

FIG. 7B is a simplified diagram illustrating an alternative exemplary embodiment of the reconfigurable multi-mode antenna of FIG. 7A. In the exemplary embodiment shown in FIG. 7B, the switch 704 and the switch 706 are in position denoted as “B” and the switch 708 is closed, such that the reconfigurable multi-mode antenna 730 is configured as a multiple loop antenna that may be used as a low frequency wireless power transmit antenna. The term “multiple loop” refers to the switches 704, 706 and 708 configuring the antenna coil 702 so that antenna segments 711, 713, 712, 714 and 715 are coupled to the input terminals 703 and 705, and form a continuous single-filar, three loop architecture. The configuration shown in FIG. 7B may be appropriate for a low frequency wireless transmit antenna application where a multiple loop antenna is desired.

In an exemplary embodiment, the reconfigurable multi-mode antenna shown in FIG. 7A and FIG. 7B (and the other embodiments described herein) can be reconfigured to adjust the number of coils, turns or loops or windings, to operate at multiple frequencies. For example, the configuration that may correspond to a higher frequency operation may have more than one turn as compared to that shown in FIG. 7A (e.g., a few more widely spaced turns) but having fewer turns than a configuration that may correspond to a lower frequency operation. Likewise, while FIG. 7B shows a configuration with a few turns, in certain aspects there may be many more turns closely spaced together (e.g., 7-8) in a configuration that may correspond to a lower frequency operation. As such, while one or more of the figures and accompanying description may illustrate a configurations' switching between one turn and a few turns, there may be a greater number of turns and coil configurations that may be switchable in accordance with the description herein.

In an exemplary embodiment, the reconfigurable multi-mode antenna shown in FIG. 7A and FIG. 7B (and the other embodiments described herein) can be reconfigured to operate at different frequencies while maintaining a uniform magnetic field, thus allowing random placement of a charge-receiving device on a wireless charging surface, such as a charging pad.

In an exemplary embodiment, the reconfigurable multi-mode antenna shown in FIG. 7A and FIG. 7B (and the other embodiments described herein) can be reconfigured so that one configuration (such as the configuration shown in FIG. 7A) may be resonant (e.g., forming part of a resonant circuit comprising capacitance and inductance selected to be electrically resonant at a particular frequency as described above) and one configuration (such as the configuration shown in FIG. 7B) may be non-resonant, or in which the reconfigurable multi-mode antenna shown in FIG. 7A and FIG. 7B (and the other embodiments described herein) can be reconfigured so that one configuration (such as the configuration shown in FIG. 7B) may be resonant and one configuration (such as the configuration shown in FIG. 7A) may be non-resonant. Alternatively both of the configurations shown in FIG. 7A and FIG. 7B may be resonant or non-resonant.

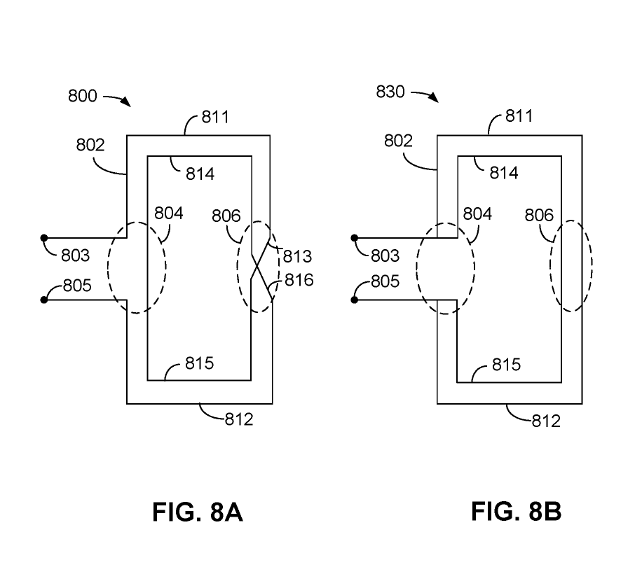

FIG. 8A is a simplified diagram illustrating an exemplary embodiment of a reconfigurable multi-mode antenna 800. The reconfigurable multi-mode antenna 800 can be associated with, contained in, or can be a portion of a pad, table, mat, lamp, or other element associated with a wireless charging system. In an exemplary embodiment, the reconfigurable multi-mode antenna 800 may be part of a pad having a wireless charging surface on which a charge-receiving device may be placed to wirelessly receive power. In an exemplary embodiment, the reconfigurable multi-mode antenna 800 comprises an antenna coil 802 having antenna segments 811, 812, 813, 814, 815 and 816. The reconfigurable multi-mode antenna 800 comprises input terminals 803 and 805. The reconfigurable multi-mode antenna 800 also comprises switch regions 804 and 806. The switch regions 804 and 806 may contain exemplary switching systems, switching methodologies, or other switching means, to reconfigure the antenna coil 802 in a plurality of reconfigurable configurations. The antenna coil 802 may be configured to operate with single-ended transmit circuity 406 in which one of the input terminals 803 and 805 may be coupled to the output of the transmit circuitry 406 and the other input terminal 803 and 805 may be coupled to a ground reference. Alternatively, the antenna coil 802 may be configured to operate with balanced (also referred to as differential) transmit circuity 406 in which the input terminals 803 and 805 may be coupled to a differential output of the transmit circuitry 406.

In an exemplary embodiment, the antenna coil 802 may be configured as a series-connected, two-turn single-filar antenna, as illustrated in FIG. 8A. In an exemplary embodiment, the switching regions 804 and 806 may comprise the ability to couple the antenna coil 802 in a series-coupled arrangement where the antenna segments 811, 812, 813, 814, 815 and 816 are coupled in series to form a transmit antenna that may be appropriate for low frequency wireless power transfer, thus increasing the intensity of the magnetic field. In the embodiment shown in FIG. 8A, the antenna coil 802 is configured to have two turns where the switch region 804 is configured to couple the input terminals 803 and 805 to the antenna segments 811 and 812, while shorting together the antenna segments 814 and 815, while switch region 806 is configured to couple the antenna segment 814 to the antenna segment 812 using the antenna segment 816, and is configured to couple the antenna segment 811 to the antenna segment 815 using the antenna segment 813. The configuration shown in FIG. 8A may be appropriate for a low frequency wireless transmit antenna application where a multiple turn antenna is desired.

FIG. 8B is a simplified diagram illustrating an alternative exemplary embodiment of the reconfigurable multi-mode antenna of FIG. 8A. In an exemplary embodiment shown in FIG. 8B, a reconfigurable multi-mode antenna 830 has an antenna coil 802 that may be configured as a parallel-connected, single-turn bifilar antenna. In an exemplary embodiment, the switching regions 804 and 806 may comprise the ability to couple the antenna coil 802 in a parallel-coupled arrangement where the antenna segments 811, 812, 814 and 815 are coupled in parallel to form a transmit antenna that may be appropriate for high frequency wireless power transfer. In the embodiment shown in FIG. 8B, the antenna coil 802 is configured as a bifilar antenna having a single turn on each of two antenna coils, one antenna coil formed by the antenna segments 811 and 812, and the other antenna coil formed by the antenna segments 814 and 815. In an exemplary embodiment, the switch region 804 is configured to couple the input terminal 803 to the antenna segment 811 and to the antenna segment 814, and is configured to couple the input terminal 805 to the antenna segment 812 and to the antenna segment 815. The switch region 806 is configured to couple the antenna segment 814 to the antenna segment 815, and is configured to couple the antenna segment 811 to the antenna segment 812. The configuration shown in FIG. 8B may be appropriate for a high frequency wireless transmit antenna application where a parallel coupled one-turn antenna coil is desired.

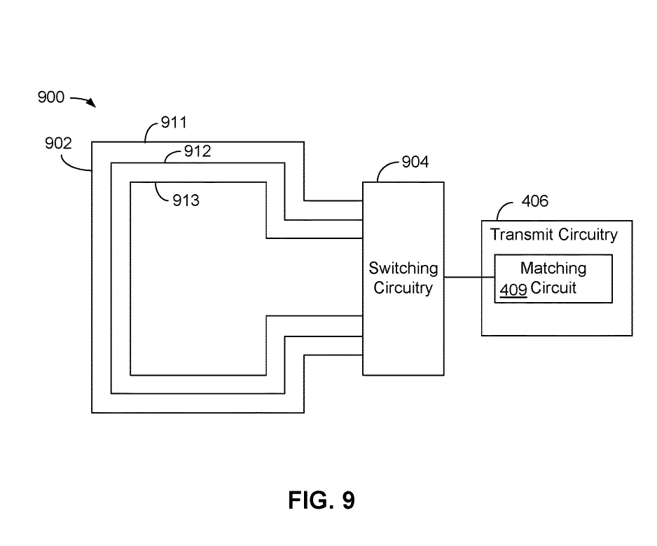

FIG. 9 is a simplified diagram illustrating an exemplary embodiment of a wireless power transfer system 900. In an exemplary embodiment, the wireless power transfer system 900 comprises a portion of the elements of a wireless power transmitter, such as the transmitter 404 of FIG. 4.

In an exemplary embodiment, the wireless power transfer system 900 comprises an antenna coil 902, switching circuitry 904 and transmit circuitry 406. In an exemplary embodiment, the antenna coil 902 may comprise antenna segments 911, 912 and 913. The switching circuitry 904 may be configured to reconfigure the antenna segments 911, 912 and 913 as, for example, a parallel coupled, single-turn, three-filar antenna suitable for high frequency wireless power transfer, or may be configured to reconfigure the antenna segments 911, 912 and 913 as a series-coupled, three turn, single-filar antenna suitable for low frequency wireless power transfer. The matching circuit 409 in the transmit circuitry 406 may be configurable to operate at both low frequencies and at high frequencies.

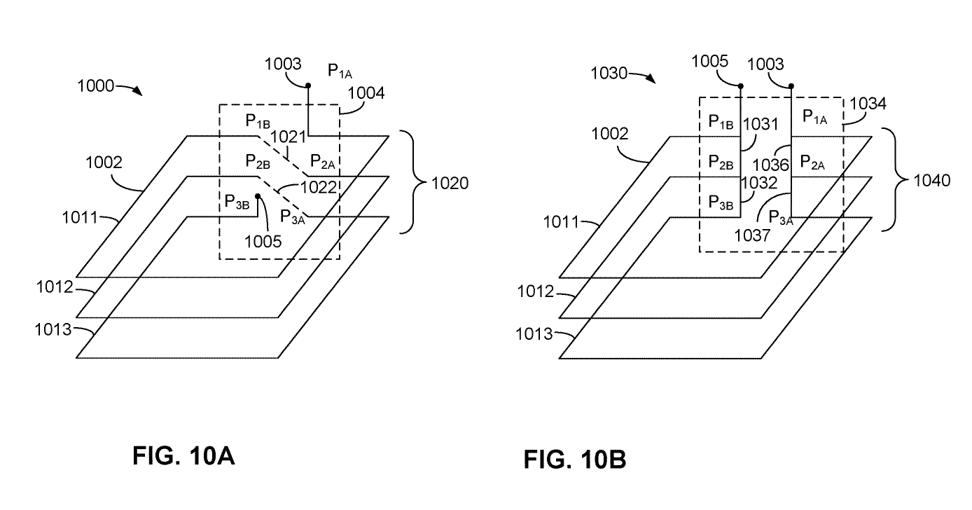

FIG. 10A is an exemplary embodiment of the antenna coil and switching circuitry of FIG. 9. In FIG. 10A an antenna system 1000 comprises an antenna coil 1002 comprising antenna segments 1011, 1012 and 1013 that may be arranged on three separate layers of a printed circuit board (PCB) 1020. The actual layers of the PCB 1020 are not shown for ease of illustration; however, each antenna segment 1011, 1012 and 1013 may be associated with a separate PCB layer. In an exemplary embodiment, the antenna coil 1002 comprises input terminals 1003 and 1005. The switching circuitry 1004 is shown schematically and in FIG. 10A, shows a series-coupled, three turn, single-filar antenna suitable for low frequency wireless power transfer, where the antenna segment 1011 is series-coupled to the antenna segment 1012 by switch connection 1021; and where the antenna segment 1012 is series-coupled to the antenna segment 1013 by switch connection 1022. In this exemplary embodiment, the antenna coil 1002 forms a three turn, single-filar antenna between the input terminal 1003 and the input terminal 1005. The configuration shown in FIG. 10A may be appropriate for a low frequency wireless transmit antenna application where a multiple turn antenna is desired.

FIG. 10B is an alternative exemplary embodiment of the antenna coil and switching circuitry of FIG. 9. In FIG. 10B, an antenna system 1030 comprises an antenna coil 1002 comprising antenna segments 1011, 1012 and 1013 that may be arranged on three separate layers of a printed circuit board (PCB) 1040. The actual layers of the PCB 1040 are not shown for ease of illustration; however, each antenna segment 1011, 1012 and 1013 may be associated with a separate PCB layer. In an exemplary embodiment, the antenna coil 1002 comprises input terminals 1003 and 1005. The switching circuitry 1034 is shown schematically and in FIG. 10B, shows a parallel-coupled, single turn, three-filar antenna suitable for high frequency wireless power transfer, where the antenna segments 1011, 1012 and 1013 are coupled in parallel to the input terminal 1005 by switch connections 1031 and 1032, and coupled to the input terminal 1003 by switch connections 1036 and 1037. In this exemplary embodiment, the antenna coil 1002 forms a single turn, three-filar antenna between the input terminal 1003 and the input terminal 1005. The configuration shown in FIG. 10B may be appropriate for a high frequency wireless transmit antenna application where a multiple turn antenna is desired.

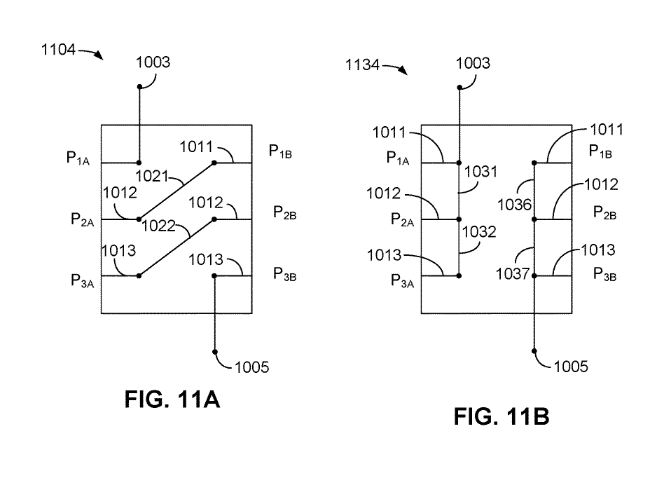

FIG. 11A is an exemplary embodiment of the switching circuitry of FIG. 10A. In an exemplary embodiment, the switching circuitry 1104 is a schematic representation of the switching circuitry 1004 of FIG. 10A. The switching circuitry 1104 is shown in FIG. 11A as a six-pole, dual throw (6P2T) switch configured to series-couple the antenna segment 1011 to the antenna segment 1012 by switch connection 1021; and configured to series-couple the antenna segment 1012 to the antenna segment 1013 by switch connection 1022, resulting in a three turn, single-filar antenna between the input terminal 1003 and the input terminal 1005.

FIG. 11B is an exemplary embodiment of the switching circuitry of FIG. 10B. In an exemplary embodiment, the switching circuitry 1134 is a schematic representation of the switching circuitry 1034 of FIG. 10A. The switching circuitry 1134 is shown in FIG. 11B as a six-pole, dual throw (6P2T) switch configured to parallel-couple the antenna segments 1011, 1012 and 1013 to the input terminal 1003 by switch connections 1031 and 1032, and configured to parallel-couple the antenna segments 1011, 1012 and 1013 to the input terminal 1005 by switch connections 1036 and 1037, resulting in a single turn, three-filar antenna between the input terminal 1003 and the input terminal 1005.

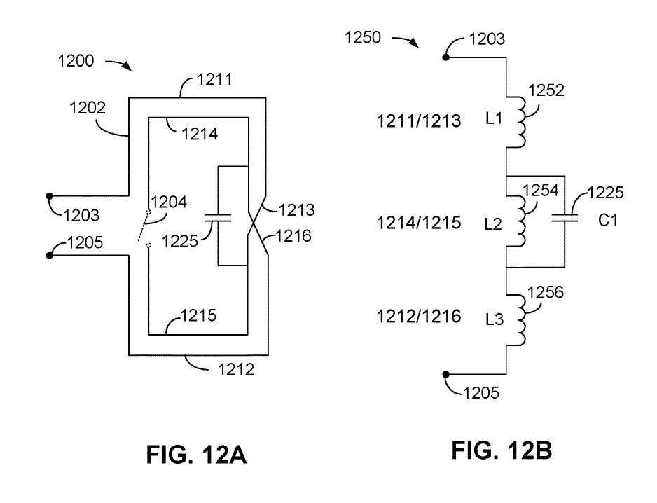

FIG. 12A is a simplified diagram illustrating an exemplary embodiment of a reconfigurable multi-mode antenna 1200. The reconfigurable multi-mode antenna 1200 can be associated with, contained in, or can be a portion of a pad, table, mat, lamp, or other element associated with a wireless charging system. In an embodiment, the reconfigurable multi-mode antenna 1200 may be part of a pad having a wireless charging surface on which a charge-receiving device may be placed to wirelessly receive power. In an exemplary embodiment, the reconfigurable multi-mode antenna 1200 comprises a capacitively-switched embodiment where the reconfigurable multi-mode antenna 1200 uses capacitance and the frequency of the wireless power transmit signal provided to the reconfigurable multi-mode antenna 1200 to determine the configuration of the reconfigurable multi-mode antenna 1200.

In an exemplary embodiment, the reconfigurable multi-mode antenna 1200 comprises an antenna coil 1202 having antenna segments 1211, 1212, 1213, 1214, 1215 and 1216. The reconfigurable multi-mode antenna 1200 comprises input terminals 1203 and 1205. The reconfigurable multi-mode antenna 1200 also comprises an optional switch 1204 and a capacitor 1225. In an exemplary embodiment, the capacitor 1225 may be configured to operate as a capacitive switch. If implemented, the switch 1204 may be similar to the switches 704, 706 and 708 described above.

The antenna coil 1202 may be configured to operate with single-ended transmit circuity 406 in which one of the input terminals 1203 and 1205 may be coupled to the output of the transmit circuitry 406 and the other input terminal 1203 and 1205 may be coupled to a ground reference. Alternatively, the antenna coil 1202 may be configured to operate with balanced (also referred to as differential) transmit circuity 406 in which the input terminals 1203 and 1205 may be coupled to a differential output of the transmit circuitry 406.

In an exemplary embodiment, the reconfigurable multi-mode antenna 1200 takes advantage of the characteristic that a capacitance generally presents a short circuit at high frequencies and an open circuit at low frequencies and an inductance generally presents a short circuit at low frequencies and an open circuit at high frequencies.

FIG. 12B is a schematic diagram 1250 showing an equivalent circuit representation of the reconfigurable multi-mode antenna 1200 of FIG. 12A. The inductor L1 1252 represents the antenna segments 1211 and 1213, the inductor L2 1254 represents the antenna segments 1214 and 1215, and the inductor L3 1256 represents the antenna segments 1212 and 1216. The optional switch 1204 is not shown in FIG. 12B.

In an exemplary embodiment, at low frequencies, the capacitor 1225 is positioned such that the capacitor 1225 is substantially an open circuit such that current flows generally through all of the antenna segments 1211, 1212, 1213, 1214, 1215 and 1216 when the optional switch 1204 is closed. This configuration provides a single-filar, two-turn antenna generally suitable for wireless power transfer at low frequencies.

In an exemplary embodiment, at high frequencies, the capacitor 1225 is substantially a short circuit such that current flows substantially through the inductor L1 1252 (antenna segments 1211 and 1213) and through the inductor L3 1256 (antenna segments 1212 and 1216), substantially bypassing the inductor L2 1254 (antenna segments 1214 and 1215). In an exemplary embodiment, at high frequencies, the switch 1204, if included, may be opened to create what is referred to as a “segmenting switch” that can be used to open the inner loop comprising the antenna segments 1214 and 1215, thus further preventing current from flowing in the antenna segments 1214 and 1215 at high frequency operation. This undesirable current can be caused by inductive coupling from the active antenna segments 1211/1213 and 1212/1216 to the inactive segments 1214 and 1215.

In an exemplary embodiment, the use of a capacitive-switching architecture, such as that shown in FIGS. 12A and 12B, generally suggests that it may be beneficial to tune the reconfigurable multi-mode antenna 1200 to resonance at a point midway between the high and the low operating frequencies. For example, for an antenna configured as a resonator designed to operate at a high frequency of 100 KHz and a low frequency of 10 MHz, the capacitor 1225 may be designed so as to achieve resonance at 1 MHz.

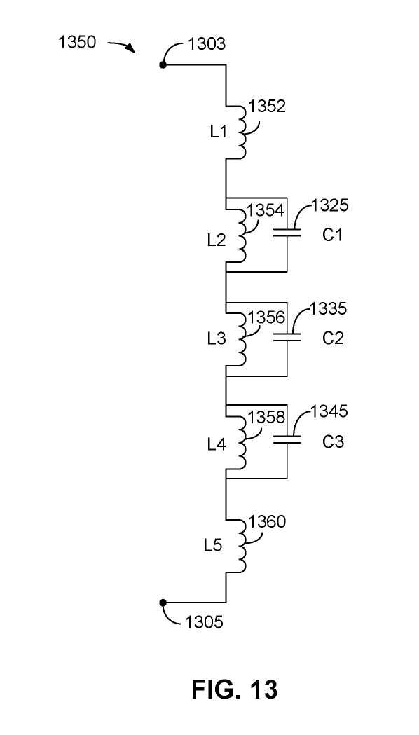

FIG. 13 is a schematic diagram showing an alternative embodiment of a circuit representation of a reconfigurable multi-mode antenna 1350. The inductor L1 1352 represents a first antenna segment, the inductor L2 1354 represents a second antenna segment, the inductor L3 1356 represents a third antenna segment, the inductor L4 1358 represents a fourth antenna segment, and the inductor L5 1360 represents a fifth antenna segment. A capacitor C1 1325 is coupled across the inductor L2 1354, a capacitor C2 1335 is coupled across the inductor L3 1356, and a capacitor C3 1345 is coupled across the inductor L4 1358. In an exemplary embodiment, the capacitors C1 1325, C2 1335 and C3 1345 can be chosen to be resonant at different frequencies, thus allowing the reconfigurable multi-mode antenna 1350 to operate at four different resonant frequencies, depending on which of the capacitors C1 1325, C2 1335 and C3 1345 are short circuits at what corresponding frequencies.

For example, at a low frequency, all of the capacitors C1 1325, C2 1335 and C3 1345 may be open circuits (non-conductive), causing the current generated in the reconfigurable multi-mode antenna 1350 to flow through all of the inductors L1 1352 through L5 1360 between the input terminals 1303 and 1305.

At a first frequency where the capacitor C1 1325 may be a short circuit (conductive) (both capacitors C2 1335 and C3 1345 may be open circuits (non-conductive)), the current generated in the reconfigurable multi-mode antenna 1350 may flow through the inductors L1 1352, L3 1356, L4 1358 and L5 1360 (bypassing the inductor L2 1354).

At a second frequency where the capacitor C1 1325 remains shorted and the capacitor C2 1335 may be a short circuit (conductive) and the capacitor C3 1345 may be an open circuit at this second frequency, the current generated in the reconfigurable multi-mode antenna 1350 may flow through the inductors L1 1352, L4 1358 and L5 1360 (bypassing the inductor L2 1354 and the inductor L3 1356).

At a third frequency where the capacitor C1 1325 and the capacitor C2 1335 remain shorted, and the capacitor C3 1345 may be a short circuit (conductive), the current generated in the reconfigurable multi-mode antenna 1350 may flow through the inductors L1 1352 and L5 1360 (bypassing the inductors L2 1354, L3 1356 and L4 1358). In this manner, the reconfigurable multi-mode antenna 1350 may be configured by the frequency of the wireless power transfer signal to be operable at a plurality of different frequencies, and may be resonant at a plurality of different frequencies.

In an exemplary embodiment, the controller 415 (FIG. 4) may be configured to receive information indicative of a type or position of a wireless power receiver and that can be configured to switch between and among the configurations described herein based on the information relating to the wireless power receiver.

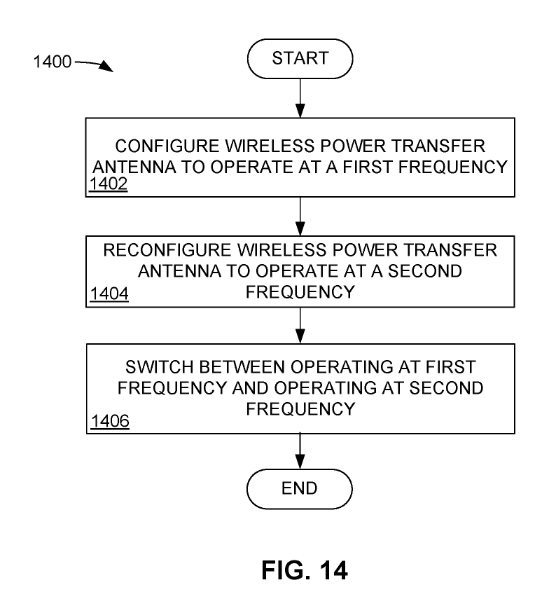

FIG. 14 is a flowchart illustrating an exemplary embodiment of a method 1400 for a reconfigurable multi-mode antenna. The blocks in the method 1400 can be performed in or out of the order shown. The description of the method 1400 will relate to the various embodiments described herein.

In block 1402, a wireless power transfer antenna is configured to operate at a first frequency.

In block 1404, the wireless power transfer antenna is reconfigured to operate at a second frequency.

In block 1406, the wireless power transfer antenna is switched between operating at a first frequency and operating at a second frequency.

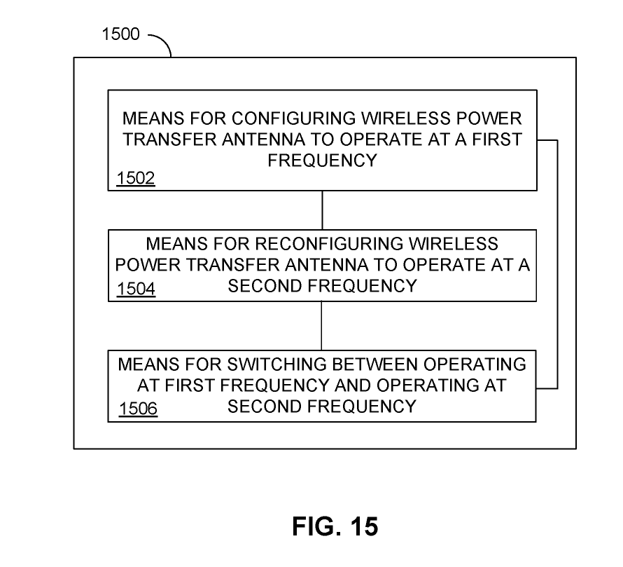

FIG. 15 is a functional block diagram of an apparatus 1500 for a reconfigurable multi-mode antenna. The apparatus 1500 comprises means 1502 for configuring a wireless power transfer antenna to operate at a first frequency. In certain embodiments, the means 1502 for configuring a wireless power transfer antenna to operate at a first frequency can be configured to perform one or more of the function described in operation block 1402 of method 1400 (FIG. 14). In an exemplary embodiment, the means 1502 for configuring a wireless power transfer antenna to operate at a first frequency may comprise the reconfigurable multi-mode antenna described herein.

The apparatus 1500 further comprises means 1504 for reconfiguring the wireless power transfer antenna to operate at a second frequency. In certain embodiments, the means 1504 for reconfiguring the wireless power transfer antenna to operate at a second frequency can be configured to perform one or more of the function described in operation block 1404 of method 1400 (FIG. 14). In an exemplary embodiment, the means 1504 for reconfiguring the wireless power transfer antenna to operate at a second frequency may comprise the reconfigurable multi-mode antenna described herein.

The apparatus 1500 further comprises means 1506 for switching between operating at the first frequency and operating at the second frequency. In certain embodiments, the means 1506 for switching between operating at the first frequency and operating at the second frequency can be configured to perform one or more of the function described in operation block 1406 of method 1400 (FIG. 14). In an exemplary embodiment, the means 1506 for switching between operating at the first frequency and operating at the second frequency may comprise the exemplary switch embodiments of the reconfigurable multi-mode antenna described herein.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and Blu-Ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1. A reconfigurable wireless power transmit antenna, comprising:
an antenna coil configured in a first configuration having a first number of turns configured to operate at a first frequency;
the antenna coil configurable in a second configuration having a second number of turns configured to operate at a second frequency; and
a switching mechanism configured to switch between the first configuration and the second configuration.

2. The reconfigurable wireless power transmit antenna of claim 1, wherein the switching mechanism comprises switches responsive to a controller and a frequency of a power transfer signal.

3. The reconfigurable wireless power transmit antenna of claim 1, wherein the antenna coil comprises a plurality of antenna segments and wherein the switching mechanism is configured to selectively electrically connect the antenna segments to form one of the first number of turns and the second number of turns.

4. The reconfigurable wireless power transmit antenna of claim 3, wherein at least one of the antenna segments forms a portion of both the first number of turns and the second number of turns.

5. The reconfigurable wireless power transmit antenna of claim 1, wherein the switching mechanism comprises a capacitor responsive to a frequency of a power transfer signal.

6. The reconfigurable wireless power transmit antenna of claim 5, wherein a plurality of capacitors are associated with a plurality of inductive antenna coil segments.

7. The reconfigurable wireless power transmit antenna of claim 5, wherein the capacitor has a capacitance that causes electrical current to flow through the capacitor to substantially bypass a portion of the antenna coil at the first frequency and the capacitor is substantially an open circuit at the second frequency to cause electrical current to flow through the portion of the antenna coil.

8. The reconfigurable wireless power transmit antenna of claim 1, wherein the switching mechanism comprises switching circuitry configured to switch the antenna coil between a series coupling and a parallel coupling.

9. The reconfigurable wireless power transmit antenna of claim 1, wherein the first number of turns is greater than the second number of turns and the first configuration corresponds to a transmit frequency at or below 1 MHz.

10. The reconfigurable wireless power transmit antenna of claim 1, wherein the first number of turns is greater than the second number of turns and the second configuration corresponds to a transmit frequency at or above 1 MHz.

11. The reconfigurable wireless power transmit antenna of claim 1, wherein the antenna coil is reconfigured to adjust a number of turns to operate at multiple frequencies.

12. The reconfigurable wireless power transmit antenna of claim 1, wherein the antenna coil is configured to switch between the first configuration and the second configuration to operate at different frequencies while maintaining a uniform magnetic field, thus allowing random placement of a charge-receiving device on a charging surface.

13. The reconfigurable wireless power transmit antenna of claim 1, wherein in the first configuration, the antenna coil is resonant and in the second configuration, the antenna coil is non-resonant.

14. The reconfigurable wireless power transmit antenna of claim 1, wherein the first frequency is lower than the second frequency and the first number of turns is greater than the second number of turns.

15. The reconfigurable wireless power transmit antenna of claim 1, further comprising a controller configured to receive information indicative of a type or position of a wireless power receiver and is configured to switch between the first configuration and the second configuration based on the information.

16. The reconfigurable wireless power transmit antenna of claim 1, wherein the antenna coil comprises a plurality of antenna coils located in different printed circuit board layers and the switching mechanism is configured to connect the plurality of antenna coils located in the different printed circuit board layers.

17. A reconfigurable wireless power transmit antenna, comprising:
an antenna coil configured in a first configuration having a first number of turns configured to operate at a first frequency;
the antenna coil configurable in a second configuration having a second number of turns configured to operate at a second frequency; and
a switching mechanism configured to switch between the first configuration and the second configuration responsive to a frequency of a wireless power transfer signal.

18. The reconfigurable wireless power transmit antenna of claim 17, wherein the antenna coil is configured to switch between the first configuration and the second configuration to operate at different frequencies while maintaining a uniform magnetic field, thus allowing random placement of a charge-receiving device on a charging surface.

19. A device for wireless power transfer, comprising:
means for configuring an antenna coil in a first configuration having a first number of turns configured to operate at a first frequency; and
means for reconfiguring the antenna coil in a second configuration having a second number of turns configured to operate at a second frequency.

20. The device of claim 19, further comprising means for switching between the first configuration and the second configuration.

21. The device of claim 19, further comprising means for configuring the antenna coil responsive to a frequency of a power transfer signal.

22. A method for wireless power transfer, comprising:
configuring an antenna coil in a first configuration having a first number of turns configured to operate at a first frequency; and
reconfiguring the antenna coil in a second configuration having a second number of turns configured to operate at a second frequency.

23. The method of claim 22, further comprising switching between the first configuration and the second configuration.

24. The method of claim 22, further comprising configuring the antenna coil responsive to a frequency of a power transfer signal.

25. The method of claim 22, further comprising configuring the antenna coil in one of a series coupling and a parallel coupling.

26. The method of claim 22, further comprising configuring the antenna coil to operate at a transmit frequency at or below 1 MHz.

27. The method of claim 22, further comprising configuring the antenna coil to operate at a transmit frequency at or above 1 MHz.

28. The method of claim 22, further comprising adjusting a number of turns of the antenna coil to operate at multiple frequencies.

29. The method of claim 22, further comprising switching between the first configuration and the second configuration to operate at different frequencies while maintaining a uniform magnetic field thus allowing random placement of a charge-receiving device on a charging surface in which the antenna coil is located, wherein in the first configuration, the antenna coil is resonant and in the second configuration, the antenna coil is non-resonant.

30. The method of claim 22, wherein in the first configuration, the antenna coil is resonant and in the second configuration, the antenna coil is non-resonant.
